(19) United States
(12) Patent Application Publication
(10) Pub. No.: US 2017/0206202 A1
(43) Pub. Date: Jul. 20, 2017

(54) PROXIMITY OF DATA TERMS BASED ON WALSH-HADAMARD TRANSFORMS

(71) Applicant: Hewlett Packard Enterprise Development LP, Houston, TX (US)

(72) Inventors: Mehran Kafai, Redwood City, CA (US); Wen Yao, San Diego, CA (US)

(21) Appl. No.: 15/324,058

(22) PCT Filed: Jul. 23, 2014
(86) PCT No.: PCT/US2014/047803

§ 371 Date: Jan. 5, 2017

(51) Int. Cl. G06F 17/30

(52) U.S. Cl. CPC G06F 17/3053; G06F 17/30321; G06F 17/30448; G06F 17/30598

(57) ABSTRACT

Determining proximity of data terms based on Walsh-Hadamard transforms is disclosed. One example is a system including a modifier, a Walsh-Hadamard transformer, an indexer, and an evaluator. A dataset, including a plurality of numerical data terms, is received via a processing system. The modifier extends a given data term of the plurality of data terms, the extension based on multiple concatenations of the given data term with itself. The Walsh-Hadamard transformer provides coefficients of the Walsh-Hadamard transform of the modified given data term. The indexer provides a set of keys based on the coefficients, and associates the set of keys with the given data term. The evaluator determines a similarity measure for a pair of data terms of the plurality of data terms, the similarity measure based on a number of overlaps between respective sets of keys, and indicative of proximity of the pair of data terms.

### BACKGROUND

A dataset is a collection of data terms. Datasets are analyzed to determine proximity of the data terms. Such proximity may be utilized in finding a data term that is proximate to a received query term.

### BRIEF DESCRIPTION OF THE DRAWINGS

FIG. 1 is a functional block diagram illustrating one example of a system for determining proximity of data terms based on Walsh-Hadamard transforms.

FIG. 2 is a block diagram illustrating one example of a processing system for implementing the system for determining proximity of data terms based on Walsh-Hadamard transforms.

FIG. 3 is a block diagram illustrating one example of a computer readable medium for determining proximity of data terms based on Walsh-Hadamard transforms.

FIG. 4 is a flow diagram illustrating one example of a method for determining proximity of data terms based on Walsh-Hadamard transforms.

### DETAILED DESCRIPTION

A dataset is a collection of data terms. Datasets are analyzed to detect proximity of the data terms. Such proximity may be utilized for an approximate nearest neighbor (“ANN”) search.

As described in various examples herein, proximity of data terms is determined based on Walsh-Hadamard transforms (“WHTs”). Such an approach may be utilized to perform probabilistic dimensionality reduction for the purpose of ANN search and indexing. ANN search via WHT indexing may be utilized for computer systems that perform in-memory big-data analysis and retrieval. A WHT is an orthogonal, non-sinusoidal transform that takes a signal as input and outputs a set of basis functions. The output functions are known as Walsh functions. A Walsh function takes two values: +1 and −1. Performing a WHT on an input signal provides a set of coefficients associated with the input signal.

As described herein, the ANN search based on a WHT takes a data term (e.g. a numerical N-dimensional vector) in a dataset and maps it to a set of H keys. Each key is an integer from the set {1, 2, . . . , U}, where U is generally much larger than N, and N is much larger than H. Generally, U may be a power of 2. For example, we may have H=100, N=6000, and U=2¹⁸. The H keys may be based on largest H coefficients provided by the WHT. So we obtain a projection of an N-dimensional object onto a lower H-dimensional object. A similarity measure between two data terms in the dataset may be determined based on a number of common keys. This provides an approximate measure of nearest neighbors in the dataset. An ANN search may then be performed. For example, a received query term may be mapped to a set of keys, and this set of keys may be utilized to search for a nearest neighbor in the dataset based on the similarity measure.

As described in various examples herein, determining proximity of data terms based on Walsh-Hadamard transforms is disclosed. One example is a system including a modifier, a Walsh-Hadamard transformer, an indexer, and an evaluator. A dataset is received via a processing system, the dataset including a plurality of numerical data terms. A numerical data term is data that may be represented numerically. In one example, a numerical data may be a vector with numerical components. As another example, a numerical data term may be a matrix with numerical entries. In one example, a data term may be represented numerically. For example, the term “True” may be represented by the number “1” and the term “False” may be represented by the number “0”. The modifier extends a given data term of the plurality of data terms, the extension based on multiple concatenations of the given data term with itself. The Walsh-Hadamard transformer applies a Walsh-Hadamard transform to the modified given data term to provide coefficients of the Walsh-Hadamard transform. The indexer provides a set of keys based on the coefficients of the Walsh-Hadamard transform, and associates the set of keys with the given data term. The evaluator determines, via the processing system, a similarity measure for a pair of data terms of the plurality of data terms, the similarity measure based on a number of overlaps between respective sets of keys, and indicative of proximity of the pair of data terms.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

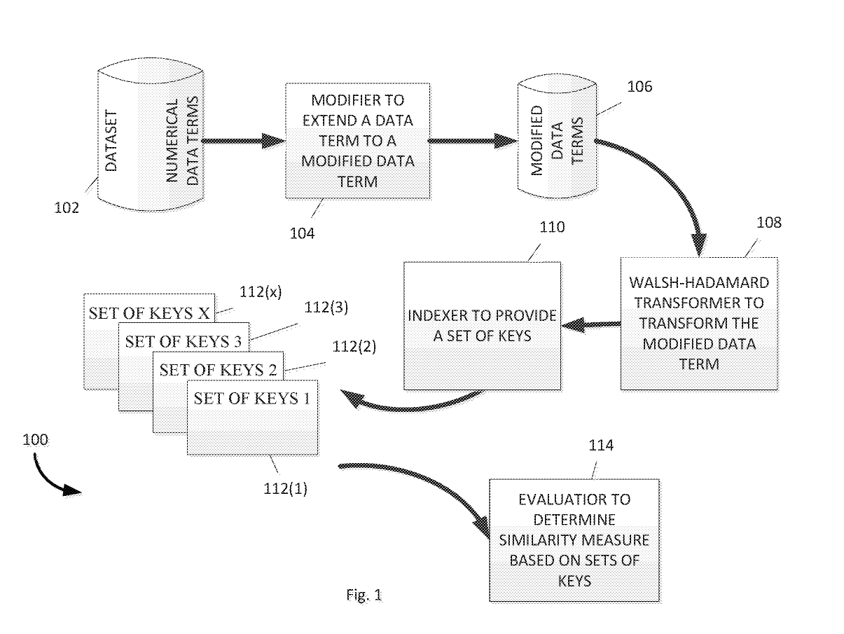

FIG. 1 is a functional block diagram illustrating one example of a system 100 for determining proximity of data terms based on Walsh-Hadamard transforms. The system 100 receives a dataset, including a plurality of numerical data terms. The system 100 extends a given data term of the plurality of data terms, the extension based on multiple concatenations of the given data term with itself. In one example, the system 100 extends each data term of the plurality of data terms into an extended data term, the extension based on concatenating each data term with itself d times. The system 100 applies a Walsh-Hadamard transform to the modified given data term to provide coefficients of the Walsh-Hadamard transform. The system 100 determines a similarity measure for a pair of data terms of the plurality of data terms, the similarity measure being based on a number of overlaps between respective associated sets of keys, and being indicative of proximity of the pair of data terms. In one example, the given data term is a vector with N components, and the modified given data term is a modified vector with U components, and the indexer associates the set of U integers with the given data term, each given integer of the set of U integers associated with the given data term if the given integer appears in the set of keys associated with the given data term. Accordingly, the plurality of data terms in the dataset may be indexed based on the Walsh-Hadamard transforms.

Such indexing represents each data term with multiple keys to increase the overall probability of overlaps. The multiple keys may correspond to selected WHT coefficient indices (e.g. the largest H indices), thereby representing a high-dimensional data term in low dimensional space. Applying the WHT is computationally more efficient than other comparable transforms. The indexing disclosed herein may be applicable to a data set with numerical data terms.

System 100 includes a dataset 102 with a plurality of numerical data terms, a modifier 104, a collection of modified data terms 106, a Walsh-Hadamard transformer 108, an indexer 110, sets of keys 112(1), 112(2), . . . , 112(x), each set of keys associated with a data term, and an evaluator 114. In one example, the dataset 102 may include a plurality of vectors with numerical, real-valued components. System 100 may be provided with values for H and U. The integer H may be experimentally determined based on the type and number of data terms in the dataset. Generally, U is a very large integer relative to H. In one example, U is a power of 2. The elements of system 100 may be implemented, for example, in software.

Modifier 104 extends a given data term of the plurality of data terms, the extension being based on multiple concatenations of the given data term with itself. In one example, the extension is based on concatenating each data term with itself d times. In one example, a vector with N numerical components may be extended by concatenating it with itself d times, where d may be selected as a floor(U/N). In one example, the extension includes adding zeros so that the modified vector has U components. For example, if d=floor(U/N), then the number of additional zeros may be U mod N. The floor of a real number is the largest integer that is smaller than the real number. For example, the floor of 2.999 is 2, the floor of 10.001 is 10, and so forth. In one example, N may be 6000, and U may be 2¹⁸. Accordingly, d=floor(2¹⁸/6000).

As another illustrative example, N may be 10, and U may be 2⁵. Accordingly, d=floor(2⁵/10)=floor(32/10)=floor(3.2)=3, and U mod N=32 mod 10=2. A vector A=<a₁, a₂, . . . , a₁₀> may be concatenated d=3 times with itself to obtain a vector: A′=<a₁, a₂, . . . , a₁₀, a₁, a₂, . . . , a₁₀, a₁, a₂, . . . a₁₀> of length 30. Two additional zeros may be added to the vector A′ to obtain a modified vector: <a₁, a₂, . . . , a₁₀, a₁, a₂, . . . , a₁₀, a₁, a₂, . . . , a₁₀, 0, 0> of length U=32.

In one example, the modifier may randomly permute components of the extended data term. For example, components of the extended vector may be permuted. In one example, the integers {1, 2, . . . , U} may be permuted, and the corresponding permutation may be applied to the modified vector with U components. For example, when U=32, the integers {1, 2, . . . , 32} may be permuted to obtain the set {32, 1, 2, . . . , 31}. Accordingly, the modified vector <a₁, a₂, . . . , a₁₀, a₁, a₂, . . . , a₁₀, a₁, a₂, . . . , a₁₀, 0, 0> may also be permuted to obtain the vector: <0, a₁, a₂, . . . , a₁₀, a₁, a₂, . . . , a₁₀, a₁, a₂, . . . , a₁₀, 0>. In general, an extension followed by a random permutation increases a likelihood of finding similarities between two data terms.

Dataset 102 is modified via modifier 104 to provide modified data terms 106. System 100 includes a Walsh-Hadamard transformer 108 to apply a Walsh-Hadamard transform to the modified given data term to provide coefficients of the Walsh-Hadamard transform. For example, after application of the Walsh-Hadamard transform to the modified vector <0, a₁, a₂, . . . , a₁₀, a₁, a₂, . . . , a₁₀, a₁, a₂, . . . , a₁₀, 0>, the Walsh-Hadamard transformer may provide a collection of coefficients c₁, c₂, . . . , cₖ.

System 100 includes an indexer 110 to provide a set of keys based on coefficients of the Walsh-Hadamard transform, and to associate the set of keys with the given data term. In one example, the highest H coefficients of the Walsh-Hadamard transform of the modified data term may be selected as the set of keys. In general, H may be much smaller than U. In one example, H may be 100, N may be 6000, and U may be 2¹⁸.

Indexer 110 provides sets of keys 112(1), 112(2), . . . , 112(x), each set corresponding to a data term, may be provided by the Walsh-Hadamard transformer 108. In one example, each 6000-dimensional vector may be associated with 100 integers selected from the set {1, 2, 3, . . . , 2¹⁸}. Accordingly, a higher dimensional data object (e.g. with 6000 dimensions) is associated with a lower dimensional index (e.g. with 100 dimensions).

In one example, the set of keys comprises coefficients of the Walsh-Hadamard transform of the modified data term. As described herein, the Walsh-Hadamard transform for a given modified data term may provide a collection of coefficients c₁, c₂, . . . , cₖ. The H largest coefficients, cₙ¹, cₙ_{₂}, . . . , cₙ_{_{H}} may be selected as the set of keys associated with the data term A.

Table 1 illustrates an example association of data terms A, B, and C, with sets of keys:

TABLE 1

| Data Term | Set of Keys |
|---|---|
| A | {1, 5, 9, 13, 16} |
| B | {2, 3, 4, 7, 13} |
| C | {1, 5, 7, 8, 11} |

In one example, the given data term may be a vector with N components, and the modified given data term may be a modified vector with U components, and the indexer 110 may associate the set of U integers with the plurality of data terms, each given integer of the set of U integers being associated with the given data term if the given integer appears in the set of keys associated with the given data term. Table 2 illustrates an example association of U=2⁴ integers {1, 2, . . . , 16} to data terms A, B, and C, based on sets of H=5 keys in Table 1:

TABLE 2

| 1 | 2 | 3 | 4 | 5 6 | 7 | 8 | 9 | 10 | 11 | 12 | 13 | 14 | 15 | 16 |
|---|---|---|---|---|---|---|---|---|---|---|---|---|---|---|
| A | | | | A | | | A | | | | A | | | A |
| | B | B | B | | B | | | | | | B | | | |
| C | | | | C | C | C | | | C | | | | | |

As illustrated, integers 1 and 5 are associated with A and C since these integers appear in the set of keys associated with A (see Table 1) and the set of keys associated with C (see Table 1). Likewise, integer 13 is associated with A and B since this integer appears in the set of keys associated with A (see Table 1) and the set of keys associated with B (see Table 1).

System 100 includes an evaluator 114 to determine a similarity measure for a pair of data terms of the plurality of data terms, the similarity measure based on a number of overlaps between respective sets of keys, and indicative of proximity of the pair of data terms. Table 3 illustrates an example determination of similarity measures for pairs formed from the data terms A, B, and C:

TABLE 3

| Data Term Pair: (X, Y) | Similarity Measure: S(X, Y) |
|---|---|
| (A, B) | S(A, B) = 1 |
| (A, C) | S(A, C) = 2 |
| (B, C) | S(B, C) = 1 |

As illustrated in Table 2, the data terms A and B have index 13 in common in their respective sets of keys. Accordingly, the similarity measure for the pair (A,B), denoted as S(A,B) may be determined to be 1. Also, for example, as illustrated in Table 2, the data terms A and C have indices 1 and 5 in common in their respective sets of keys. Accordingly, the similarity measure for the pair (A,C), denoted as S(A,C) may be determined to be 2. As another example, as illustrated in Table 2, the data terms B and C have index 7 in common in their respective sets of keys. Accordingly, the similarity measure for the pair (B,C), denoted as S(B,C) may be determined to be 1.

In one example, system 100 may further include a receiver (not illustrated in FIG. 1) to receive a query term. In one example, the query term may be a vector with numerical components. The modifier 104 may extend the query term, and the Walsh-Hadamard transformer 108 may apply a Walsh-Hadamard transform to the modified query term to provide coefficients for the modified query term. As described herein, the indexer 110 may associate the query term with a set of keys, the set of keys based on the coefficients for the modified query term. Table 4 illustrates an example query term Q associated with a set of keys:

TABLE 4

| Query Term | Set of Keys |
|---|---|
| Q | {1, 5, 6, 7, 9, 10, 13} |

In one example, system 100 may include a classifier (not illustrated in FIG. 1) to generate a list of data terms of the plurality of data terms, the list generated based on the set of keys associated with the modified query term. In one example, the classifier may rank the list of data terms based on a similarity measure of the query term with each data term in the list of data terms. Table 5 illustrates an example list of terms associated with the query term Q illustrated in Table 4, and the corresponding similarity measures.

TABLE 5

| | | | | | | | Similarity |
|---|---|---|---|---|---|---|---|
| 1 | 5 | 6 | 7 | 9 | 10 | 13 | Measures |
| A | A | | | A | | A | S(Q, A) = 4 |
| | | | B | | | B | S(Q, B) = 2 |
| C | C | | C | | | | S(Q, C) = 3 |

As illustrated, the set of keys associated with the query term Q (see Table 4) may be compared with the indexed data terms illustrated in Table 2. Based on such comparison, index 1 appears in the set of keys associated with Q and index 1 is also associated with data terms A and C. Also, for example, index 5 appears in the set of keys associated with Q and index 5 is also associated with data terms A and C. As another example, index 13 appears in the set of keys associated with Q and index 13 is also associated with data terms A and B. The frequency of occurrence of A is 4. This is also the similarity measure for the pair Q and A. The frequency of occurrence of B is 2. This is also the similarity measure for the pair Q and B. The frequency of occurrence of C is 3. This is also the similarity measure for the pair Q and C.

In one example, the classifier may rank the list of data terms based on a similarity measure of the query term with each data term in the list of data terms. Based on the example illustrated in Table 5, the classifier may rank the list of data terms as A, C, and B.

In one example, the classifier provides, in response to the query term, at least one data term from the list of data terms based on the ranking. In the example illustrated in Table 5, based on the ranking, the at least one data term may be selected as A, and the classifier may provide A in response to the query term Q. Accordingly, A may be determined as a nearest neighbor for the query term Q.

In one example, the ranking may not provide an unambiguous candidate for the at least one data term. In such instances, in one example, more than one data term may be provided in response to the query term. Also, for example, if data terms D and E are determined to have the same ranking, then additional measures of similarity may be utilized to determine if D or E may be provided in response to the query term. For example, cosine similarities may be determined for the pairs (D,Q) and (E,Q), and D or E may be selected based on the respective cosine similarities.

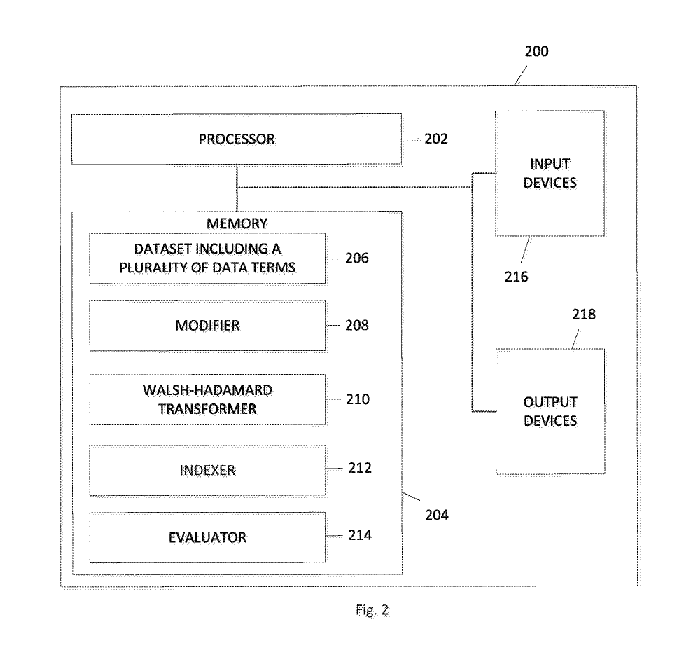

FIG. 2 is a block diagram illustrating one example of a processing system 200 for implementing the system 100 for determining proximity of data terms based on Walsh-Hadamard transforms. Processing system 200 includes a processor 202, a memory 204, input devices 216, and output devices 218. Processor 202, memory 204, input devices 216, and output devices 218 are coupled to each other through communication link (e.g., a bus).

Processor 202 includes a Central Processing Unit (CPU) or another suitable processor. In one example, memory 204 stores machine readable instructions executed by processor 202 for operating processing system 200. Memory 204 includes any suitable combination of volatile and/or non-volatile memory, such as combinations of Random Access Memory (RAM), Read-Only Memory (ROM), flash memory, and/or other suitable memory.

Memory 204 stores dataset 206, including a plurality of data terms, for processing by processing system 200. Memory 204 also stores instructions to be executed by processor 202 including instructions for a modifier 208, a Walsh-Hadamard transformer 210, an indexer 212, and an evaluator 214. In one example, modifier 208, Walsh-Hadamard transformer 210, indexer 212, and evaluator 214, include modifier 104, Walsh-Hadamard transformer 108, indexer 110, and evaluator 114, respectively, as previously described and illustrated with reference to FIG. 1.

In one example, processor 202 executes instructions of modifier 208 to modify dataset 206 to extend a given data term of the plurality of data terms, the extension being based on multiple concatenations of the given data term with itself. In one example, processor 202 executes instructions of modifier 208 to extend a vector with N numerical components by concatenating it with itself d times, where d may be selected as the floor(U/N). In one example, processor 202 executes instructions of modifier 208 to randomly permute components of the extended given data term.

Processor 202 executes instructions of Walsh-Hadamard transformer 210 to apply a Walsh-Hadamard transform to the modified given data term to provide coefficients of the Walsh-Hadamard transform.

Processor 202 executes instructions of an indexer 212 to provide a set of keys based on coefficients of the Walsh-Hadamard transform, and to associate the set of keys with the given data term. In one example, highest H coefficients of the Walsh-Hadamard transform of the modified given data term may be selected as the set of keys. In one example, the given data term may be a vector with N components, and the modified given data term may be a modified vector with U components, and processor 202 executes instructions of an indexer 212 to associate the set of U integers with the plurality of data terms, each given integer of the set of U integers being associated with the given data term if the given integer appears in the set of keys associated with the given data term.

Processor 202 executes instructions of an evaluator 214 to determine a similarity measure for a pair of data terms of the plurality of data terms, the similarity measure based on a number of overlaps between respective sets of keys, and indicative of proximity of the pair of data terms.

In one example, processor 202 executes instructions of a receiver (not illustrated in FIG. 2) to receive a query term. In one example, processor 202 executes instructions of modifier 208 to extend the query term. In one example, processor 202 executes instructions of Walsh-Hadamard transformer 210 to apply a Walsh-Hadamard transform to the modified query term to provide coefficients for the modified query term. In one example, processor 202 executes instructions of indexer 212 to provide a set of keys based on coefficients of the Walsh-Hadamard transform, and to associate the set of keys with the query term. In one example, processor 202 executes instructions of a classifier (not illustrated in FIG. 2) to generate a list of data terms of the plurality of data terms, the list generated based on the set of keys associated with the modified query term. In one example, processor 202 executes instructions of a classifier to rank the list of data terms based on a similarity measure of the query term with each data term in the list of data terms. In one example, processor 202 executes instructions of a classifier to provide, in response to the query term, at least one data term from the list of data terms based on the ranking.

Input devices 216 include a keyboard, mouse, data ports, and/or other suitable devices for inputting information into processing system 200. In one example, input devices 216 are used to input a query term. Output devices 218 include a monitor, speakers, data ports, and/or other suitable devices for outputting information from processing system 200. In one example, output devices 218 are used to provide responses to the query term. For example, output devices 218 may provide the at least one data term.

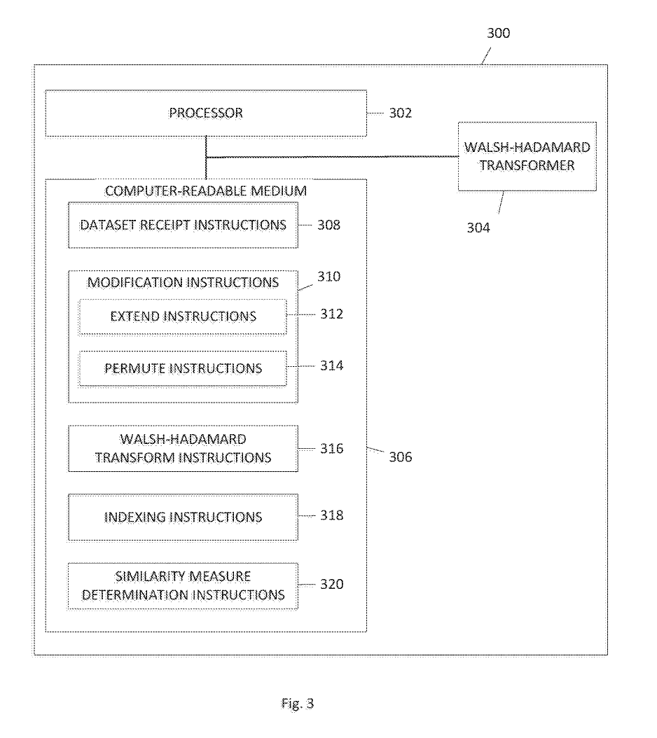

FIG. 3 is a block diagram illustrating one example of a computer readable medium for determining proximity of data terms based on Walsh-Hadamard transforms. Processing system 300 includes a processor 302, a computer readable medium 306, and a Walsh-Hadamard transformer 304. Processor 302, computer readable medium 306, and the Walsh-Hadamard transformer 304 are coupled to each other through communication link (e.g., a bus).

Processor 302 executes instructions included in the computer readable medium 306. Computer readable medium 306 includes dataset receipt instructions 308 to receive a dataset. The dataset receipt instructions 308 include instructions to receive a plurality of plurality of vectors with numerical components. Computer readable medium 306 includes modification instructions 310 of a modifier to modify a given vector of the plurality of vectors into a modified given vector. The modification instructions 310 comprising further extend instructions 312 to extend the given vector by concatenating it with itself multiple times. The modification instructions 310 comprising further permute instructions 314 to randomly permute the components of the extended given vector.

Computer readable medium 306 includes Walsh-Hadamard transform instructions 316 of the Walsh-Hadamard transformer 304 to apply a Walsh-Hadamard transform to the modified given vector to provide coefficients of the Walsh-Hadamard transform. Computer readable medium 306 includes indexing instructions of an indexer 318 to associate a set of keys with the given vector, the set of keys based on the coefficients of the Walsh-Hadamard transform. In one example, highest H coefficients of the Walsh-Hadamard transform of the modified given vector may be selected as the set of keys. In one example, the given vector may have N components, and the modified given vector may have U components, and computer readable medium 306 includes indexing instructions of an indexer 318 to associate the set of U integers with the given vector, each given integer of the set of U integers being associated with the given vector if the given integer appears in the set of keys associated with the given vector. Computer readable medium 306 includes similarity measure determination instructions 320 of an evaluator to determine a similarity measure for a pair of vectors of the plurality of vectors, the similarity measure based on a number of overlaps between respective sets of keys, and indicative of proximity of the pair of vectors.

In one example, computer readable medium 306 includes instructions to receive a query vector, associate the query vector with a set of keys, and provide at least one vector of the plurality of vectors based on the set of keys associated with the query vector.

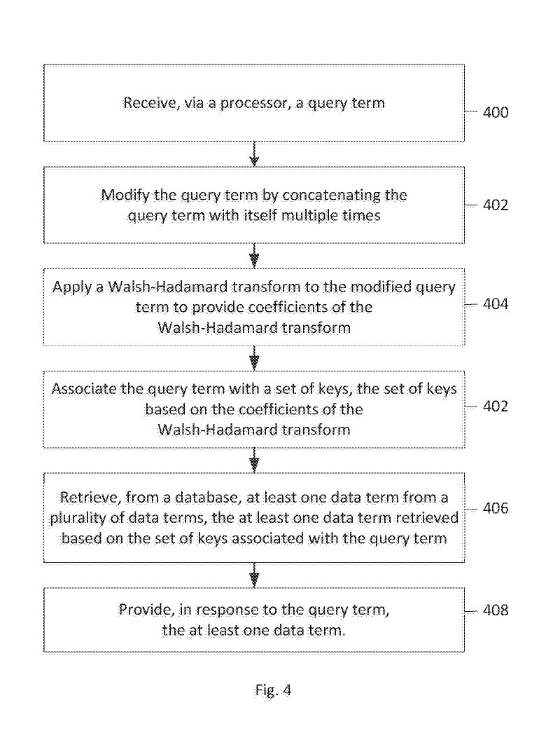

FIG. 4 is a flow diagram illustrating one example of a method for determining proximity of data terms based on Walsh-Hadamard transforms. At 400, a query term is received. At 402, the query term is modified by concatenating the query term with itself multiple times. At 404, a Walsh-Hadamard transform is applied to the modified query term to provide coefficients of the Walsh-Hadamard transform. At 406, the query term is associated with a set of keys, the set of keys based on the coefficients of the Walsh-Hadamard transform. At 408, at least one data term is retrieved from a plurality of data terms, the at least one data term being retrieved based on the set of keys associated with the query term. At 410, the at least one data term is provided in response to the query term.

In one example, modifying the query term may include randomly permuting the components of the concatenated query term.

In one example, the associated set of keys may include indices of the Walsh-Hadamard transform of the modified query term.

In one example, the query term is a vector with N components, and the modified query term is a modified vector with U components, and the indexer associates the set of U integers with the vector, each given integer of the set of U integers associated with the vector if the given integer appears in the set of keys associated with the vector.

In one example, the database may include an association of the set of U integers with the plurality of data terms, each given integer of the set of U integers being associated with a given data term if the given integer appears in the set of keys associated with the given data term.

Examples of the disclosure provide a generalized system for determining proximity of data terms based on Walsh-Hadamard transforms. The generalized system provides an automatable approach to perform probabilistic dimensionality reduction for the purpose of ANN search and indexing. ANN search via WHT indexing may be utilized for computer systems that perform in-memory big-data analysis and retrieval.

Although specific examples have been illustrated and described herein, especially as related to healthcare data, the examples illustrate applications to any structured data. Accordingly, there may be a variety of alternate and/or equivalent implementations that may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a dataset received via a processing system, the dataset including a plurality of numerical data terms;
a modifier to extend a given data term of the plurality of data terms, the extension based on multiple concatenations of the given data term with itself;
a Walsh-Hadamard transformer to apply a Walsh-Hadamard transform to the modified given data term to provide coefficients of the Walsh-Hadamard transform;
an indexer to provide a set of keys based on the coefficients of the Walsh-Hadamard transform, and to associate the set of keys with the given data term; and
an evaluator to determine, via the processing system, a similarity measure for a pair of data terms of the plurality of data terms, the similarity measure based on a number of overlaps between respective sets of keys, and indicative of proximity of the pair of data terms.

2. The system of claim 1, wherein the modifier randomly permutes components of the extended data term.

3. The system of claim 1, wherein the given data term is a vector with N components, and the modified given data term is a modified vector with U components, wherein U is considerably larger than N, and the indexer associates the set of U integers with the given data term, each given integer of the set of U integers associated with the given data term if the given integer appears in the set of keys associated with the given data term.

4. The system of claim 3, wherein the set of keys comprises H largest coefficients of the Walsh-Hadamard transform, wherein H is considerably smaller than N.

5. The system of claim 1, further comprising a receiver to receive a query term, and wherein:
the modifier extends the query term;
the Walsh-Hadamard transformer applies the Walsh-Hadamard transform to the modified query term to provide coefficients for the modified query term; and
the indexer associates the query term with a set of keys, the set of keys based on the coefficients for the modified query term.

6. The system of claim 5, further comprising:
a classifier to generate a list of data terms of the plurality of data terms, the list generated based on the set of keys associated with the modified query term.

7. The system of claim 6, wherein the classifier ranks the list of data terms based on a similarity measure of the query term with each data term in the list of data terms.

8. The system of claim 7, wherein the classifier provides, in response to the query term, at least one data term from the list of data terms based on the ranking.

9. A method to find an approximate nearest neighbor in a database, the method comprising:
receiving, via a processor, a query term;
modifying the query term by concatenating the query term with itself multiple times;
applying a Walsh-Hadamard transform to the modified query term to provide coefficients of the Walsh-Hadamard transform;
associating the query term with a set of keys, the set of keys based on the coefficients of the Walsh-Hadamard transform;
retrieving, from the database, at least one data term from a plurality of data terms, the at least one data term retrieved based on the set of keys associated with the query term; and
providing, in response to the query term, the at least one data term.

10. The method of claim 9, wherein modifying the query term further comprises randomly permuting the components of the concatenated query term.

11. The method of claim 9, wherein the query term is a vector with N components, and the modified query term is a modified vector with U components, and the indexer associates the set of U integers with the vector, each given integer of the set of U integers associated with the vector if the given integer appears in the set of keys associated with the vector.

12. The method of claim 9, wherein the database comprises an association of the set of U integers with the plurality of data terms, each given integer of the set of U integers associated with a given data term if the given integer appears in the set of keys associated with the given data term.

13. A non-transitory computer readable medium comprising executable instructions to:
receive a dataset via a processor, the dataset including a plurality of vectors with numerical components;
modify a given vector of the plurality of vectors into a modified given vector, the instructions to modify comprising further instructions to:
extend the given vector by concatenating it with itself multiple times, and
randomly permute the components of the extended given vector;
apply a Walsh-Hadamard transform to the modified given vector to provide coefficients of the Walsh-Hadamard transform;
associate a set of keys with the given vector, the set of keys based on the coefficients of the Walsh-Hadamard transform; and
determine, via the processor, a similarity measure for a pair of vectors of the plurality of vectors, the similarity measure based on a number of overlaps between respective sets of keys, and indicative of proximity of the pair of vectors.

14. The non-transitory computer readable medium of claim 13, wherein the given vector has N components, and the modified given vector has U components, wherein U is considerably larger than N, and further including instructions to:
associate the set of U integers with the given vector, each given integer of the set of U integers associated with the given vector if the given integer appears in the set of keys associated with the given vector.

15. The non-transitory computer readable medium of claim 13, further including instructions to:
receive a query vector;
associate the query vector with a set of keys; and
provide at least one vector of the plurality of vectors based on the set of keys associated with the query vector.
